(19) United States
(12) Patent Application Publication
(10) Pub. No.: US 2025/0283608 A1
(43) Pub. Date: Sep. 11, 2025

(54) BOTTLE FOR INSERTING INTO A KITCHEN AND/OR CATERING DEVICE, A KITCHEN AND/OR CATERING DEVICE AND AN ARRANGEMENT

(71) Applicant: Welbilt Deutschland GmbH, Eglfing (DE)

(72) Inventors: Sebastian SIEBERT, Neubeuern (DE); Georg TIETZE, Kochel am See (DE); Herbert FISCHHABER, Peißenberg (DE)

(21) Appl. No.: 19/059,074

(22) Filed: Feb. 20, 2025

(30) Foreign Application Priority Data
Mar. 7, 2024 (DE) 102024106600.8

(51) Int. Cl. F24C 14/00; B08B 3/08; F24C 15/00

(52) U.S. Cl. CPC F24C 14/005; B08B 3/08; F24C 15/003

(57) ABSTRACT

The invention relates to a bottle for inserting into a kitchen and/or catering device, wherein the bottle is filled with a water-soluble additive, in particular a cleaner, descaling agent or rinse aid, wherein the additive is solid, wherein the bottle comprises a bottom, an opening arranged opposite the bottom and a lateral surface, wherein the lateral surface extends from the bottom to the opening and wherein a bottle length is defined from the bottom to the opening, wherein the bottle comprises a supporting portion along the bottle length, wherein the lateral surface comprises a flattened supporting surface in the entire supporting portion, wherein the supporting portion extends over at least one third of the bottle length.

### CROSS-REFERENCE TO RELATED APPLICATION

This application claims priority to German Patent Application No. 102024106600.8, entitled “Bottle for Inserting Into a Kitchen and/or Catering Device, a Kitchen and/or Catering Device and an Arrangement” and filed on Mar. 7, 2024, which is expressly incorporated by reference herein in its entirety.

### TECHNICAL FIELD

The invention relates to a bottle for inserting into a kitchen and/or catering device, the kitchen and/or catering device and an arrangement of two of the bottles and the kitchen and/or catering device.

### BACKGROUND

U.S. Pat. No. 10,767,871B2 shows prior art. A cleaning device for commercial cooking devices is described herein. The cleaning device comprises a connecting unit, in particular a receiving neck, for receiving a container with a solids cleaning agent, a liquefaction device for liquefying the solids cleaning agent, optionally using a solvent, and optionally at least a first storage tank.

### SUMMARY

The object of the invention is to provide a bottle for inserting into a kitchen and/or catering device, which is easy to manufacture and as stable as possible and/or as easy as possible to handle and/or enables safe operation of the kitchen and/or catering device.

The solution to this object is achieved by the features of the independent claims. The dependent claims relate to preferred embodiments of the invention.

The invention relates to a bottle for a kitchen and/or catering device. This device is designed in particular for commercial use in catering or for domestic use in a kitchen. The device is preferably a cooking device. For example, the device is designed as a combi-steamer. Alternatively, the device can be designed, for example, as a warming oven or baking oven.

In order to better understand the function and structure of the bottle according to the invention, the structure of the kitchen and/or catering device according to the invention, in which the bottle is used, is first explained. This kitchen and/or catering device comprises a food chamber for treatment and/or storage of food. The device preferably comprises a housing, wherein the food chamber is arranged within the housing. If the device is designed as a cooking device, the food chamber can also be formed as cooking chamber. In or at the food chamber, there is preferably a heating/recirculation unit that makes it possible to heat the food chamber and/or to apply recirculating air to it. In particular, the heating/circulating air unit can also be used to generate steam, which can be used to treat the food in the food chamber.

Furthermore, the kitchen and/or catering device preferably comprises a collecting container for storing a liquid washing liquor. The collecting container is preferably arranged below the food chamber. A recirculation is particularly preferably provided, which makes it possible to lead the washing liquor from the food chamber back to the collecting container. The recirculation can be formed as a drain channel leading from the food chamber to the collecting container.

The collecting container is preferably connected to the food chamber via a washing liquor line/pipe. This washing liquor line is formed and arranged to supply the washing liquor from the collecting container to the food chamber. A washing liquor pump is particularly preferably provided, which delivers the washing liquor through the washing liquor line into the food chamber. In particular, the kitchen and/or catering device is configured to distribute the washing liquor in the food chamber to the walls of the food chamber in order to clean the food chamber. The washing liquor flows together at the bottom of the food chamber and can be led back into the collecting container via the recirculation described.

To prepare the washing liquor, fresh water is enriched with an additive. This additive can be, for example, a cleaner or a descaling agent or a rinse aid. In the context of the present invention, it is provided that the additive is not liquid at room temperature, but is solid and is arranged in the bottle. The bottle contains additive for several cleaning processes, so that only a part of the additive needs to be dissolved from the bottle. Therefore, the kitchen and/or catering device comprises at least one solids unit. The individual solids unit comprises: a receptacle for inserting the bottle, a supply line leading to the receptacle for supplying a fluid that dissolves the additive, and a discharge line, which leads from the receptacle, to discharge the fluid together with the dissolved additive.

Thus, the task is solved by a bottle for inserting into the kitchen and/or catering device, wherein the bottle is filled with a water-soluble additive, in particular a cleaner, descaling agent or rinse aid, wherein the additive is solid. “Solid” means, in particular, that the additive, before being dissolved in water, is neither free-flowing nor capable of flowing. The term “solid” additive preferably also refers to “gel-like” additives.

The bottle is preferably in a one-piece and/or made of plastic. Unless otherwise stated, the dimensions provided for diameters, lengths and widths are external dimensions.

The bottle comprises a bottom, an opening opposite the bottom, and a lateral surface, wherein the lateral surface extends from the bottom to the opening and wherein a bottle length is defined from the bottom to the opening. Preferably, the bottle is closed at the bottom by the material of the bottle, whereby there is no opening and no closure at the bottom. A closure can be arranged at the opening, which is removed before the use of the bottle or is broken through when the bottle is inserted.

The bottle comprises a supporting portion along the bottle length, wherein the lateral surface has a flattened supporting surface over the entire supporting portion, wherein the supporting portion extends over at least one third of the bottle length. The supporting surface makes the bottle easy to handle, as the bottle can be gripped at the supporting portion in a non-rotatable manner and thus in a defined orientation. Furthermore, the supporting portion, in combination with a corresponding geometry in the receptacle of the kitchen and/or catering device, allows the bottle to be inserted only into a specific receptacle and not into a wrong receptacle, thereby increasing safety during operation of the kitchen and/or catering device.

Preferably, a bottle diameter is defined at each position along the bottle length, wherein the largest dimension must be measured perpendicularly to the plane of the supporting surface. This imaginary plane of the supporting surface rests on the outside of the supporting surface. If the supporting surface is slightly curved, the plane of the supporting surface is defined as being centered on the supporting surface and tangential to the supporting surface. Preferably, the bottle diameter is not larger at any position outside the supporting portion than the largest bottle diameter in the supporting portion. This allows the supporting surface to be led at a corresponding inner surface of the receptacle, when the bottle is inserted into the receptacle of the kitchen and/or catering device.

Preferably, the bottle comprises only one supporting surface. This provides an easily recognizable orientation of the bottle, when it is inserted into the receptacle of the kitchen and/or catering device.

Preferably, the lateral surface in the supporting portions, with the exception of the supporting surface, is cylindrical; but it can also be, at least in places, curved or conical.

Preferably, the supporting surface is flat or curved outwards with a radius of at least 50 cm, preferably at least 100 cm. The relatively large radius results in an approximately flat design of the supporting surface.

The supporting surface comprises a supporting surface length along the bottle length and a supporting surface width perpendicular thereto. Preferably, the supporting surface length is at least three times of the supporting surface width. Preferably, the supporting surface width is at least 4 cm. Additionally or alternatively, the supporting surface preferably covers at least 30, preferably at least 50, square centimeters. The long and/or large configuration of the supporting surface makes the bottle easy to handle. Furthermore, a guiding surface that is as long and/or large as possible is advantageous when inserting the bottle into the receptacle of the kitchen and/or catering device.

The bottle preferably comprises a center portion and an opening portion, wherein the supporting portion is arranged in the center portion. The bottle preferably tapers from the center portion to the opening portion. As a result, the opening portion has a relatively small diameter, which simplifies the sealing of the opening portion within the receptacle of the kitchen and/or catering device.

Preferably, the middle portion transitions to the opening portion via a sensor surface, wherein the sensor surface is perpendicular to the lateral surface in the opening portion, with a deviation of up to +/−30°, preferably at up to +/−5°. As will be described later, this sensor surface can press on a bottle sensor in the receptacle of the kitchen and/or catering device.

Preferably, the opening portion is cylindrical. Preferably, the opening portion has an opening portion length of at least 3 cm. Preferably, the opening portion is formed threadlessly for plugging into a seal. These measures simplify the sealing of the opening portion within the receptacle of the kitchen and/or catering device.

The opening portion has an opening portion diameter and the center portion has a center portion diameter. The center portion can have different diameters, wherein the largest diameter in the center portion is relevant. The opening portion preferably has only a uniform diameter.

Preferably, the largest center portion diameter is at least 1.2 times, preferably at least 1.3 times, of the opening portion Diameter. Additionally, or alternatively, the largest center portion diameter is at most 2.5 times, preferably at most 2 times, of the opening portion Diameter.

An opening portion center axis is defined at the opening portion and a center portion center axis is defined at the center portion. Both center axes are preferably parallel to each other and parallel to the bottle length. The opening portion center axis is preferably offset relative to the center portion center axis toward the underside of the bottle. This offset of the two center axes preferably defines the position of the underside.

Preferably, the lateral surface extends in the interior of the bottle at the underside without an increase in inclination-preferably without an edge—from the center region via the opening portion up to the opening. This makes it possible to completely empty the bottle.

A vertical is defined perpendicular to the underside. Preferably, the supporting surface is at an angle of 10° to 60°, preferably 10° to 45°, particularly preferably 15° to 25°, to the vertical. Additionally, or alternatively, the plane of the supporting surface forms an acute angle with the vertical in the upper half of the bottle, i.e. opposite the underside.

The lateral surface between the supporting portion and the bottom preferably comprises a narrowing to form a grip portion. This allows the bottle to be gripped with one hand at the grip portion and with the other hand at the supporting surface.

Preferably, the narrowing is horseshoe-shaped. This horseshoe shape particularly describes that the narrowing is not formed over the entire circumference. Preferably, the bottle is not narrowed at the underside, whereby the dissolved solids can also preferably flow out completely from the grip portion. The open portion of the horseshoe shape is thus arranged at the underside of the bottle.

Preferably, the largest grip portion diameter of the grip portion is smaller than the largest center portion diameter. This ensures that the grip portion is preferably not too large and can be easily grasped by one hand.

The invention further comprises the already described kitchen and/or catering device, in particular a cooking device. Preferably, the solids unit of the kitchen and/or catering device comprises the bottle sensor, wherein the bottle sensor comprises a pin that is linearly movable in inserting direction of the bottle and is operable by the bottle, in particular the sensor surface of the bottle.

Preferably, the kitchen and/or catering device comprises at least two of the solids units, wherein the two solids units differ from one another in the receiving portion for the respective bottle via different asymmetrical cross-sections.

The designs described in the description and in the claims for the bottle are advantageously used in the kitchen and/or catering device according to the invention.

The invention further comprises an arrangement of two of the described bottles and the kitchen and/or catering device, wherein the two bottles comprise the supporting surface on different sides and the two solids units are designed such that the first bottle fits only into the first solids unit and the second bottle fits only into the second solids unit.

The configurations described in the description and in the claims for the bottle and/or the kitchen and/or catering device are advantageously used in the arrangement according to the invention.

### BRIEF DESCRIPTION OF THE DRAWINGS

Further details, advantages and features of the present invention will become apparent from following description of embodiments based on the drawing. It shows in:

FIG. 1 a first view of the bottle according an embodiment of the invention,

FIG. 2 a further view of the bottle according the embodiment of the invention,

FIG. 3 a sectional view of the bottle according the embodiment of the invention,

FIG. 4 a perspective view of the bottle according the embodiment of the invention,

FIG. 5 a perspective view of the bottle with hands gripping it according to the embodiment of the invention,

FIG. 6 a schematic side view and front view of a kitchen and/or catering device according the embodiment of the invention,

FIG. 7 a detailed representation of the kitchen and/or catering with two of the bottles according the embodiment of the invention,

FIG. 8 a further detailed representation of the kitchen and/or catering device with two of the bottles according the embodiment of the invention, and

FIG. 9 a further detailed representation of the kitchen and/or catering device together with the bottle according the embodiment of the invention.

### DETAILED DESCRIPTION

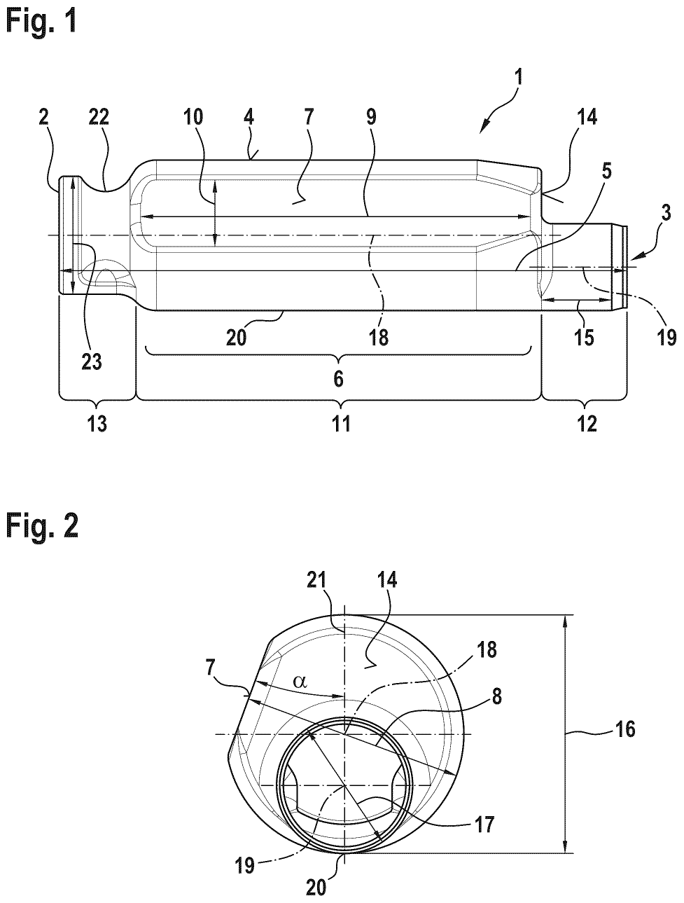

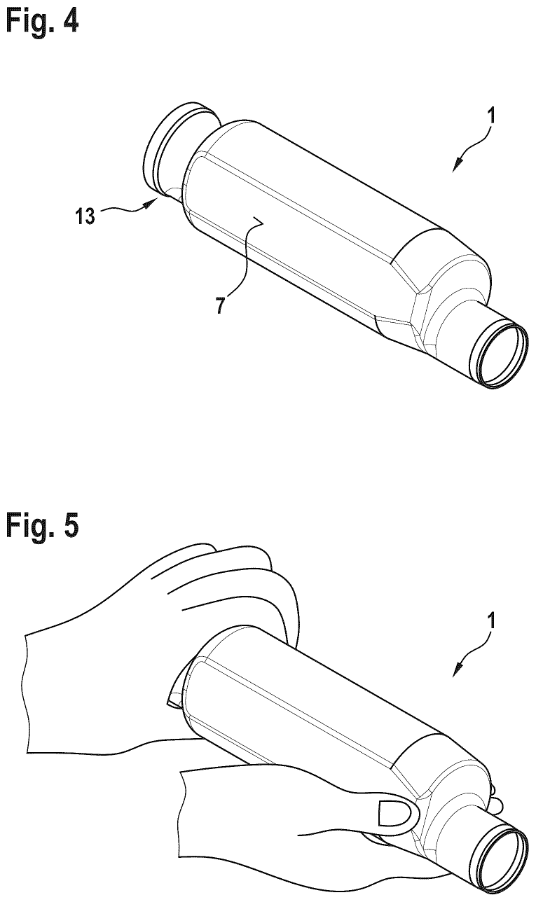

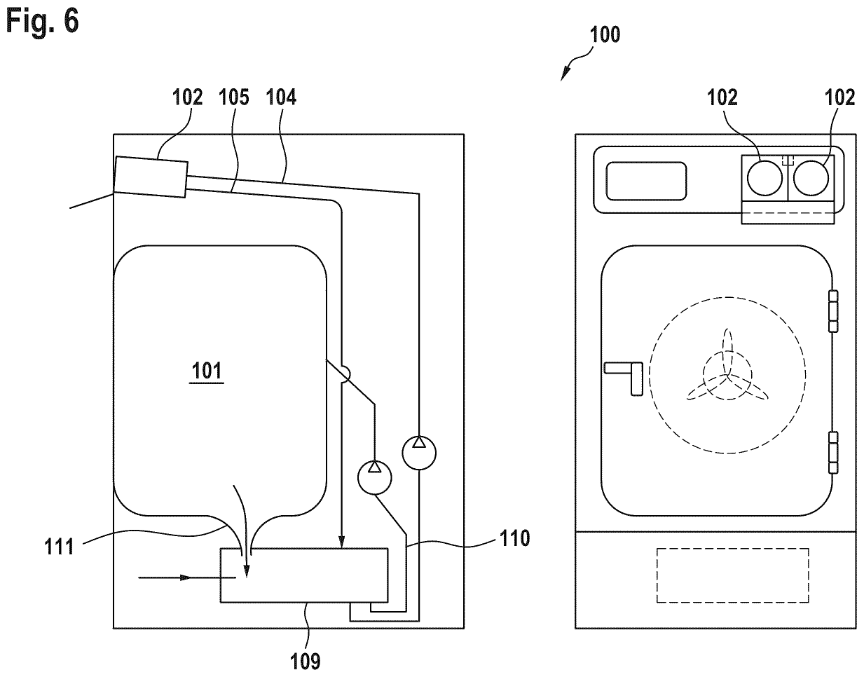

FIGS. 1 to 5 show a bottle 1 for inserting into a kitchen and/or catering device 100 according to FIGS. 6 to 9. Two of the bottles 1 and the kitchen and/or catering device 1 form an arrangement.

In the following, unless otherwise stated, reference is always made to all figures.

The bottle shown is filled with a water-soluble additive. The bottle 1 is in one piece and made of plastic. The bottle 1 comprises a bottom 2, an opening 3 opposite the bottom 2 and a lateral surface 4, wherein the lateral surface 4 extends from the bottom 2 to the opening 3 and wherein a bottle length 5 is defined from the bottom 2 to the opening 3. The bottle 1 is closed at the bottom 2 by the material of the bottle 1, whereby there is no opening and no closure at the bottom 2. At the opening 3 there can be a closure, not shown, which is removed before the bottle 1 is used or is broken through when the bottle 1 is inserted.

The bottle 1 comprises a supporting portion 6 along the bottle length 5, wherein the lateral surface 4 has a flattened supporting surface 7 in the entire supporting portion 6, wherein the supporting portion 6 extends over at least one third of the bottle length 5.

A bottle diameter 8 is defined at each position along the bottle length 5, wherein the largest dimension must be measured perpendicularly to the plane of the supporting surface 7. This imaginary plane of the supporting surface 7 rests outside of the supporting surface 7. The bottle diameter 8 is not larger at any position outside the supporting portion 6 than the largest bottle diameter 8 in the supporting portion 6.

The bottle 1 comprises only one supporting surface 7. The lateral surface 4 is cylindrical in the supporting portion 6 with the exception of the supporting surface 7. The supporting surface 7 is flat.

The supporting surface 7 comprises a supporting surface length 9 along the bottle length 5 and a supporting surface width 10 perpendicular to this. The preferred ratio of supporting surface length 9 and supporting surface width 10 is defined in the general part of the description and also applies to the embodiment.

The bottle 1 comprises a center portion 11 and an opening portion 12, wherein the supporting portion 6 is arranged in the center portion 11. The bottle 1 tapers from the center portion 11 into the opening portion 12.

The center portion 11 merges with a sensor surface 14 in the opening portion 12, wherein the sensor surface 14 is perpendicular to the lateral surface 4 in the opening portion 12.

The opening portion 12 is cylindrical. The opening portion 12 has an opening portion length 15 of at least 3 cm. The opening portion 12 is formed threadlessly for plugging into a seal 108 (see FIG. 9).

The opening portion 12 has an opening portion diameter 17 and the center portion 11 has a center portion diameter 16. The center portion 11 can have different diameters, wherein the largest diameter in the center portion 11 is relevant here. The opening portion 12 has only one uniform diameter. The dimensions of the center portion diameter 16 and the opening portion diameter 17 are defined in the general part of the description and also apply to the embodiment.

An opening portion center axis 19 is defined at the opening portion 12 and a center portion center axis 18 is defined at the center portion 11. Both center axes 18, 19 are parallel to each other and parallel to the bottle length 5. The opening portion center axis 19 is offset relative to the center portion center axis 18 toward the underside 20 of the bottle 1.

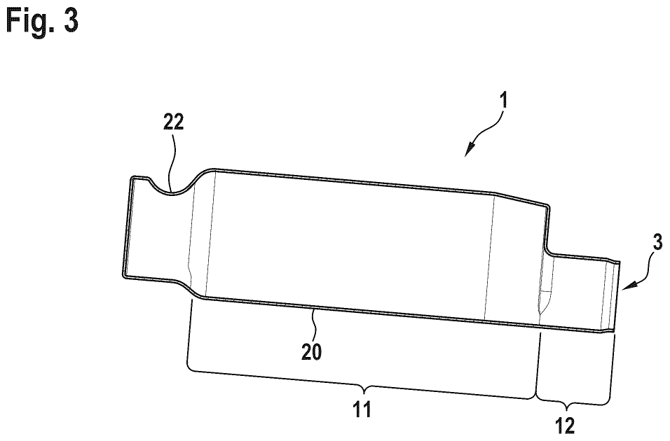

As is shown in particular by the sectional view in FIG. 3, the lateral surface 4 inside the bottle 1 at the underside 20 runs without any increase in inclination from the center portion 11 via the opening portion 12 to the opening 3.

A vertical 21 is defined perpendicular to the underside 20. The supporting surface 7 is at an angle α of 15° to 25° to the vertical 21. The plane of the supporting surface 7 in the upper half of the bottle—i.e. opposite the underside-forms an acute angle with the vertical 21.

The lateral surface 4 comprises a narrowing 22 between the supporting portion 6 and the bottom 2 to form a grip portion 13. This allows the bottle 1 to be gripped with one hand at the grip portion 13 and with the other hand at the supporting surface 7; this is illustrated in particular in FIG. 5.

The narrowing 22 is horseshoe-shaped. This horseshoe shape means that the narrowing 22 is not fully formed. The bottle 1 is not narrowed at the underside 20.

A largest grip portion diameter 23 of the grip portion 13 is smaller than the largest center portion diameter 16 of the center portion. Thus, the grip portion 13 is not too large and can be easily grasped by one hand.

FIG. 6 shows a purely schematic illustration of a side view and a front view of the kitchen and/or catering device 100, in which the bottle 1 is used.

The kitchen and/or catering device 100 is constructed as explained in the general part of the description. Accordingly, the kitchen and/or catering device 100 comprises a food chamber 101 and a collecting container 109 arranged thereunder. A washing liquor line 110 leads to the food chamber 101 from the collecting container 109. A pump for pumping the washing liquor into the food chamber 101 can be arranged in this washing liquor line 110. From the food chamber 101, the washing liquor can flow back to the collecting container 109 via a recirculation 111. A fresh water supply line is provided to supply fresh water into the collecting container 102. At least one corresponding supply line 104 with a supply line pump leads from the collecting container 109 to the solids units 102. At least one discharge line 105 leads from the solids units 102 to the collecting container 109.

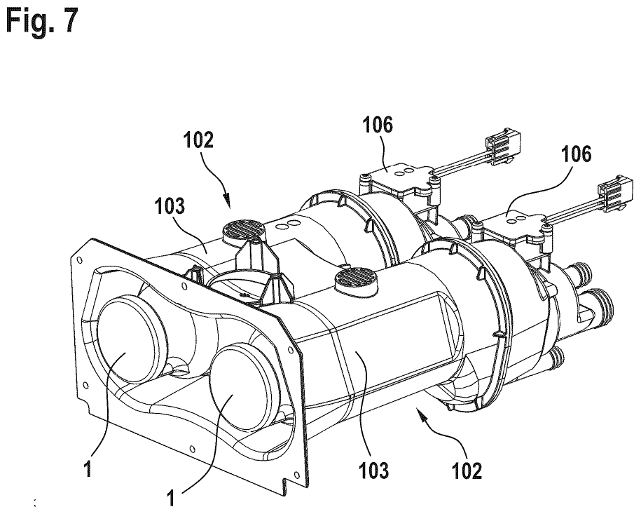

FIGS. 7 to 9 show the solids units 102 in detail. The individual solids unit 102 comprises a receptacle 103 for inserting the bottle 1.

Each solids unit 102 comprises a bottle sensor 106, wherein the bottle sensor 106 comprises a pin 107 that is linearly movable in inserting direction of the bottle 1 and is operable by the bottle 1, in particular the sensor surface 14 of the bottle 1.

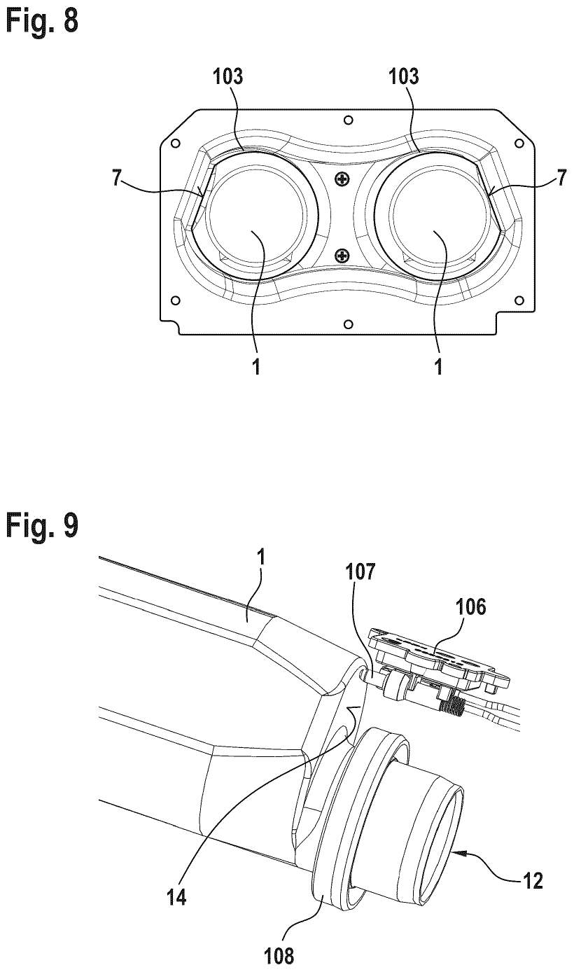

The kitchen and/or catering device 1 comprises two of the solids units 102, wherein the two solids units 102 in the receiving portion for the respective bottle 1 differ from one another via different asymmetrical cross-sections. This is illustrated in FIG. 8.

What is claimed is:

1. A bottle for inserting into a kitchen and/or catering device, wherein:
the bottle is filled with a water-soluble additive, in particular a cleaner, a descaling agent or a rinse aid, wherein the additive is solid,
the bottle comprises a bottom, an opening arranged opposite the bottom, and a lateral surface, wherein the lateral surface extends from the bottom to the opening and wherein a bottle length is defined from the bottom to the opening, and
the bottle comprises a supporting portion along the bottle length, wherein the lateral surface comprises a flattened supporting surface in the entire supporting portion, wherein the supporting portion extends over at least one third of the bottle length.

2. The bottle of claim 1, wherein:
a bottle diameter is defined at each position along the bottle length,
the largest dimension must be measured perpendicularly to a plane of the supporting surface, and
the bottle diameter is at no position outside the supporting portion larger than the largest bottle diameter in the supporting portion.

3. The bottle of claim 1, wherein:
the bottle comprises only one supporting surface, and/or
the lateral surface is cylindrical in the supporting portion with exception of the supporting surface, and/or
the supporting surface is flat or is curved outwards with a radius of at least 50 cm, preferably at least 100 cm.

4. The bottle of claim 1, wherein:
the supporting surface comprises a supporting surface length along the bottle length and a supporting surface width perpendicular thereto,
the supporting surface length is at least three times of the supporting surface width, and/or
the supporting surface is at least 30, preferably at least 50, square centimeters in size.

5. The bottle of claim 1, wherein:
the bottle comprises a center portion and an opening portion,
the supporting portion is arranged in the center portion, and
the bottle tapers from the center portion into the opening portion.

6. The bottle of claim 5, wherein:
the center portion merges into the opening portion via a sensor surface, and
the sensor surface is perpendicular to the lateral surface in the opening portion, with a deviation of up to +/−30°, preferably up to +/−5°.

7. The bottle of claim 5, wherein:
the opening portion is cylindrical; and/or
the opening portion comprises an opening portion length of at least 3 cm, and/or
the opening portion is formed threadlessly for plugging into a seal.

8. The bottle of claim 5, wherein:
the opening portion has an opening portion diameter and the center portion has a center portion diameter,
the largest center portion diameter is at least 1.2 times, preferably at least 1.3 times, of the opening portion diameter; and/or
the largest center portion diameter is at most 2.5 times, preferably at most 2 times, of the opening portion diameter.

9. The bottle of claim 5, wherein:
an opening portion center axis is defined at the opening portion and a center portion center axis is defined at the center portion, and
the opening portion center axis is offset relative to the center portion center axis towards an underside of the bottle.

10. The bottle of claim 9, wherein:
the lateral surface extends in an interior of the bottle at the underside without increasing of an inclination from the center portion via the opening portion up to the opening, and/or
a vertical is defined perpendicular to the underside,
the supporting surface is at an angle of 10° to 60°, preferably 10° to 45°, particularly preferably 15° to 25°, to the vertical, and/or
a plane of the supporting surface forms an acute angle with the vertical in an upper half of the bottle.

11. The bottle of claim 1, wherein:
the lateral surface between supporting portion and bottom comprises a narrowing to form a grip portion,
the narrowing is horseshoe-shaped, and
this horseshoe shape describes that the narrowing is not formed at an entire circumference and the bottle is not narrowed at an underside.

12. A kitchen and/or catering device, in particular cooking device, comprising:
a food chamber for treating and/or storing food, in particular formed as cooking chamber, and
at least one solids unit with:
a receptacle for inserting a bottle of claim 1,
a supply line leading to the receptacle for supplying a fluid dissolving additive, and
a discharge line leading away from the receptacle for discharging the fluid together with the dissolved additive.

13. The kitchen and/or catering device of claim 12, wherein:
the solids unit comprises a bottle sensor, and
the bottle sensor comprises a pin, which is linearly movable in inserting direction of the bottle and is operable by the bottle.

14. The kitchen and/or catering device of claim 12, comprising at least two of the solids units, wherein the two solids units differ from one another in a receiving portion for the respective bottle via different asymmetrical cross-sections.

15. An arrangement of two bottles, respectively of one of claim 1, and a kitchen and/or catering device of claim 14, wherein the two bottles comprise the supporting surface at different sides and the two solids units are designed such that the first bottle fits only into the first solids unit and the second bottle fits only into the second solids unit.
